(19) United States
(12) Patent Application Publication
(10) Pub. No.: US 2003/0026529 A1
(43) Pub. Date: Feb. 6, 2003

(54) Optical demultiplexer

(76) Inventors: Michael Kevan Durkin, Southampton (GB); Mikhail Nickolaos Zervas, Southampton (GB)

Correspondence Address: REIDLAW, L.L.C., 1926 SOUTH VALLEYVIEW LANE, SPOKANE, WA, 99212-0157, US

(21) Appl. No.: 10/209,768

(22) Filed: Aug. 1, 2002

(30) Foreign Application Priority Data
Aug. 6, 2001 (GB) 0119154.3

(51) Int. Cl. G02B 6/293; G02B 6/26; G02B 6/34

(52) U.S. Cl. 385/24; 385/15; 385/37

(57) ABSTRACT

An apparatus for demultiplexing a wavelength division multiplexed optical signal includes a plurality of wavelength channels each having a different signal wavelength. The apparatus includes a signal port and a plurality of grating modules. Each grating module has a coupler and a fiber Bragg grating which has a unique wavelength. The grating modules each have an input port, an optical tap, and an output port. The grating modules are configured in a row having a first end and a second end. This is accomplished by connecting the output port of each grating module to the input port of another grating module. The first end of the row of grating modules is connected to the signal port. The Bragg gratings reflect different signal wavelengths.

### CROSS REFERENCE TO RELATED APPLICATIONS

The present application claims priority to United Kingdom Patent Application no. 0119154.3, filed Aug. 6, 2001 in the United Kingdom.

### FIELD OF INVENTION

The present invention relates to methods and apparatus for demultiplexing optical signals.

### BACKGROUND OF THE INVENTION

High speed, high capacity optical communication systems are increasingly based upon optical networks employing dense-wavelength-division-multiplexing (DWDM) technology whereby many optical wavelength channels are transmitted along an optical fiber simultaneously. The wavelength channels are defined in grids whereby each wavelength channel is typically separated by 200 GHz, 100 GHz, 50 GHz or 25 GHz from the next wavelength channel. The trend is to increase the number of channels and also to increase the bandwidth of each channel. This has led to two different extreme requirements, namely wavelength channels transmitting at 40 Gbit/s on a 50 or 100 GHz grid, and wavelength channels transmitting at 10 Gbit/s on a 12.5, 25 or 50 GHz grid.

Most high-speed optical networks deployed today use ring topologies containing nodes containing optical add-drop multiplexers for removing and inserting optical wavelength channels into the ring. Channels are either routed to detectors or to an add-drop multiplexer for insertion into another ring. The nodes typically contain an optical tap for removing control signals communicated around the ring, a dispersion compensator for compensating for the dispersion built up during transmission between nodes, an optical amplifier for boosting the signal and a demultiplexer. Following the demultiplexer there is provided passive routing of individual wavelength channels to detectors, multiplexers or other devices, and wavelength channels are also added.

The design of the nodes has become more complex as the bandwidth of each wavelength channel has increased. There are more and more components, and each component adds dispersion which is often undesirable. Further, there are disadvantages with current approaches in the numbers of components, losses, and the effectiveness of dispersion compensation. There is a requirement for reducing the losses in wavelength demultiplexers. There is also a requirement to improve the effectiveness of dispersion compensation at nodes in the optical network. Yet a further requirement is to reduce the number of components used to dispersion compensate and demultiplex optical signals. There is also a requirement to provide a wavelength demultiplexer in which the fiber Bragg gratings compensate for the dispersion added by other components within the node, such that an optical network can be built with many such nodes without causing complicated dispersion management issues.

An aim of the present invention is to provide a wavelength demultiplexer for integration in the nodes of an optical network.

### SUMMARY OF THE INVENTION

According to a non-limiting embodiment of the present invention there is provided apparatus for demultiplexing a wavelength division multiplexed optical signal having a plurality of wavelength channels each at a different signal wavelength. The apparatus includes a signal port and a plurality of grating modules each having a coupler and a fiber Bragg grating having a unique wavelength. The grating modules each have an input port, an optical tap and an output port. The grating modules are configured in a row having a first end and a second end by connecting the output port of each grating module to the input port of another grating module. The first end of the row of gratings is connected to the signal port, and the Bragg gratings reflect different signal wavelengths. The coupler can be, by way of example only, a beam splitter, an optical fiber coupler, a circulator, a switch, or any other device that separates an input optical signal into at least two outputs.

The grating module can also include a plurality of gratings reflecting at unique wavelengths. The fiber Bragg grating can be a broadband fiber Bragg grating designed to reflect more than one wavelength channel. The wavelength channels are preferably adjacent. The fiber Bragg grating can be a multi channel fiber Bragg grating designed to reflect more than one wavelength channel. Preferably, the wavelength channels are not adjacent. At least one of the fiber Bragg gratings can be a dispersion compensator. The dispersion compensator can be a tuneable dispersion compensator.

The optical taps can be connected to one or more optical demultiplexers which can have a plurality of input ports. At least one of the optical taps can be connected to an optical multiplexer. The optical multiplexer can be an arrayed waveguide grating or be constructed from a plurality of thin-film filters. At least one of the optical taps can be connected to a detector. Further, at least one of the optical taps can be connected to an optical switch.

The second end of the row of gratings can be connected to a detector. The optical signal can further include a control signal at a control wavelength selected to pass through the grating modules to the second end of the row of gratings.

The apparatus can further include an express path through which wavelength channels can pass through the apparatus from the first end to the second end of the row of gratings. The second end of the row of gratings can be connected to a telecommunication cable.

The grating modules can include “add ports” for adding wavelength channels into the express path.

The apparatus can comprise a signal port, a grating module comprising a coupler and a fiber Bragg grating, and a filter having a group delay characteristic. The fiber Bragg grating has a reflective group delay characteristic and an operating wavelength range. The filter has a group delay variation around the grating's operating wavelength range. The apparatus is configured such that the signal passes through the filter at least once and is reflected by the grating, and the reflective group delay characteristic provides a controlled group delay around the grating's operating wavelength range.

The filter can be a thin film filter, an arrayed waveguide grating, a fiber Bragg grating, or any other device that separates one wavelength channel from another wavelength channel.

The apparatus can be configured such that the signal passes through the filter once. It is preferable that the reflective group delay characteristic around the grating's operating wavelength range is substantially equal to a desired amount minus the filter's group delay characteristic.

The apparatus can be configured such that the signal passes through the filter twice. It is preferable that the reflective group delay characteristic around the grating's operating wavelength range is substantially equal to a desired amount minus twice the filter's group delay characteristic.

The apparatus can comprise a plurality of filters and be configured such that the signal passes through the plurality of filters at least once. It is preferable that the reflective group delay characteristic around the grating's operating wavelength range is substantially equal to a desired amount minus the sum of the accumulated group delay arising from the plurality filter's group delay characteristics at the operating wavelength range.

The desired amount can be a constant, a substantially linear variation with wavelength, or be defined by a non-linear variation with wavelength.

These and other aspects and embodiments of the present invention will now be described in detail with reference to the accompanying drawings, wherein:

### DESCRIPTION OF THE DRAWINGS

FIG. 1 depicts apparatus for demultiplexing a wavelength division multiplexed optical signal according to one embodiment of the present invention;

FIG. 2 depicts an apparatus further comprising a demultiplexer according to another embodiment of the present invention;

FIG. 3 depicts an apparatus further comprising an optical multiplexer/demultiplexer according to yet another embodiment of the present invention;

FIG. 4 depicts a prior art wavelength division multiplexer/demultiplexer comprising a dispersion compensator;

FIG. 5 depicts apparatus for demultiplexing a wavelength division multiplexed optical signal according to another embodiment of the present invention, having a first and second row of grating modules;

FIG. 6 depicts odd and even wavelength channels;

FIG. 7 depicts odd and even blocks of channels;

FIG. 8 depicts blocks of non-adjacent channels;

FIG. 9 depicts apparatus for demultiplexing a wavelength division multiplexed optical signal according to another embodiment of the present invention, wherein the apparatus includes dispersion compensators;

FIG. 10 depicts a row of grating modules comprising gratings designed to compensate for the dispersion induced by gratings in other grating modules according to another embodiment of the present invention;

FIG. 11 depicts a row of grating modules having gratings designed to compensate for the dispersion induced by gratings in the same grating module according to another embodiment of the present invention;

FIG. 12 depicts odd and even grating modules connected together according to another embodiment of the present invention;

FIG. 13 depicts a grating module having a four-port circulator according to another embodiment of the present invention;

FIG. 14 depicts a grating module having a four-port circulator and a multi-channel grating according to another embodiment of the present invention;

FIG. 15 depicts a filter according to an embodiment of the present invention;

FIG. 16 depicts a grating module having first and second circulators according to another embodiment of the present invention;

FIG. 17 depicts an add-drop multiplexer according to another embodiment of the present invention;

FIG. 18 depicts a grating module having a six-port circulator according to another embodiment of the present invention;

FIG. 19 depicts a grating module having a five-port circulator according to another embodiment of the present invention;

FIG. 20 depicts an apparatus according to another embodiment of the present invention wherein the apparatus includes thin-film filters;

FIG. 21 depicts a demultiplexer having high-channel isolation according to another embodiment of the present invention;

FIG. 22 depicts a demultiplexer in which group delay is controlled;

FIG. 23 depicts the spectral characteristic of the filter shown in FIG. 22;

FIG. 24 depicts the group delay characteristic of the filter shown in FIG. 22;

FIGS. 25 to 28 depict various arrangements of filters; and

FIG. 29 depicts group delay variation with wavelength.

### DETAILED DESCRIPTION OF PREFERRED EMBODIMENTS OF THE INVENTION

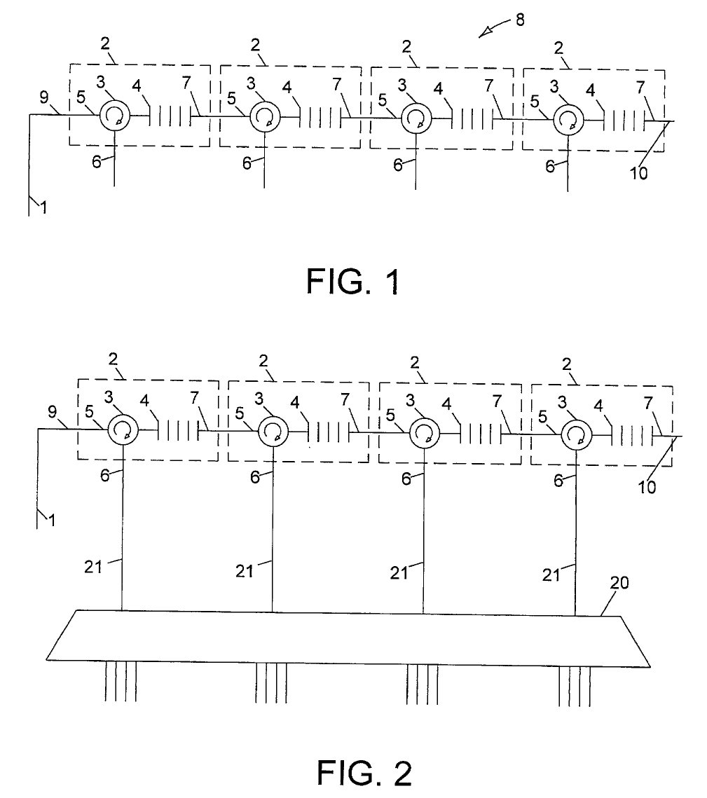

With reference to FIG. 1, there is provided apparatus for demultiplexing a wavelength division multiplexed optical signal having a plurality of wavelength channels each having a different signal wavelength, which apparatus includes a signal port 1, and a plurality of grating modules 2 each having a coupler 3 and a fiber Bragg grating 4 having a unique wavelength. The grating modules 2 each have an input port 5, an optical tap 6 and an output port 7. The grating modules 2 are configured in a row 8 having a first end 9 and a second end 10. This is done by connecting the output port 7 of each grating module 2 to the input port 5 of another grating module 2. The first end 9 is connected to the signal port 1. The Bragg gratings 4 reflect different signal wavelengths.

The coupler 3 can be, by way of example only, a beam splitter, an optical fiber coupler, a circulator, a switch, or any other device that separates an input optical signal into at least two outputs. At least one grating module 2 can include a plurality of gratings 4 reflecting at unique wavelengths. At least one fiber Bragg grating 4 can be a broadband fiber Bragg grating designed to reflect more than one wavelength channel. Preferably, the wavelength channels are adjacent. At least one of the fiber Bragg gratings 4 can be a multi channel fiber Bragg grating designed to reflect more than one wavelength channel. Preferably, the wavelength channels are not adjacent.

The apparatus can further include an optical demultiplexer 20 as shown in FIG. 2 having a plurality of demultiplexer input ports 21 and wherein the optical taps 6 are connected to the second demultiplexer input ports 21. This apparatus is particular useful when the grating modules 2 reflect wavelength channels that are well separated. For example, the optical signal can include 16 wavelength division multiplexing channels that are separated by 25 GHz, the grating modules 2 can be configured to reflect four wavelength channels each separated by 100 GHz, and the wavelength channels reflected from each of the four grating modules 2 being interleaved with respect to each other. This arrangement allows a lower-performance and lower-cost demultiplexer to be used to separate out the sixteen wavelength channels. The demultiplexer 20 can be based on arrayed waveguide grating, thin-film or liquid crystal technologies.

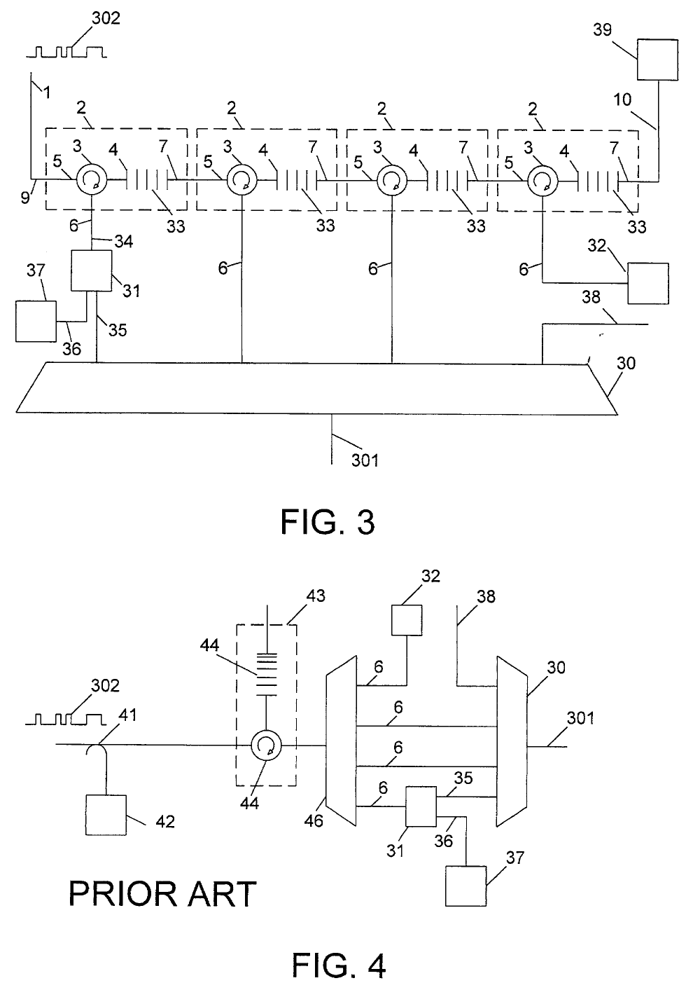

FIG. 3 depicts an apparatus further having an optical multiplexer 30, a switch 31, detectors 32 and 39, an “add port” 38, and an output 301. In the apparatus of FIG. 3 the fiber Bragg gratings 4 are dispersion compensators 33 each centered on different signal wavelengths and different ones of the optical taps 6 are connected to the optical multiplexer 30, the switch 31 and the detector 32. The switch 31 includes an input 34 and first and second outputs 35, 36. The first output 35 is connected to the optical multiplexer 30 and the second output 36 is connected to a detector 37. The add port 38 adds a different optical signal having a wavelength corresponding to the wavelength channel routed to the detector 32.

The optical multiplexer 30 can include an arrayed waveguide grating, a plurality of thin-film filters, an optical multiplexer which includes fiber Bragg gratings or a combination of arrayed waveguide gratings, thin-film filters, and fiber Bragg gratings.

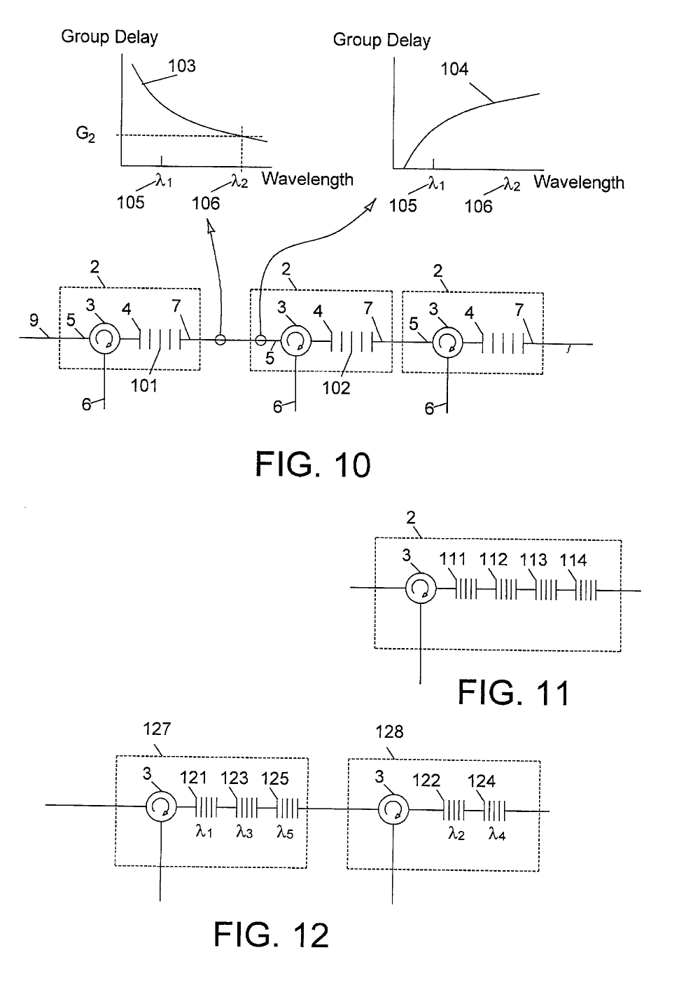

Preferably, the dispersion of the optical multiplexer 30 and the dispersion of the transmission path through the preceding fiber gratings 4 are taken into account in the design of each fiber grating 4 in order to improve the overall dispersion performance of the optical multiplexer 30. This is further described with reference to FIG. 10.

The optical signal further includes a control signal 302 at a control wavelength selected to pass through the grating modules 2 to the second end 10. The second end 10 is connected to a detector 39. Preferably, the control signal is optically filtered using a thin-film filter or a fiber Bragg grating prior inserted between the second end and the detector.

A prior art configuration is depicted in FIG. 4. The apparatus depicted in FIG. 4 includes a wavelength division multiplexing coupler 41 for separating out the control signal 302 and routing it to a detector 42, a dispersion compensator 43, and a demultiplexer 46. The dispersion compensator 43 can include a circulator 44 and a chirped fiber Bragg grating 45. Alternatively, the dispersion compensator 43 can include a length of dispersion compensating fiber or a bulk grating arrangement.

The embodiment depicted in FIG. 3 combines the dispersion compensation and the multiplexing functionalities, and has advantages over prior art devices, such as those depicted in FIG. 4. These advantages include providing lower loss, fewer components, and integrated dispersion compensation units that can be either actively or passively thermally compensated. Advantageously, it can also compensate for the dispersion of the various optical components shown in FIG. 3 as described further with reference to FIG. 10.

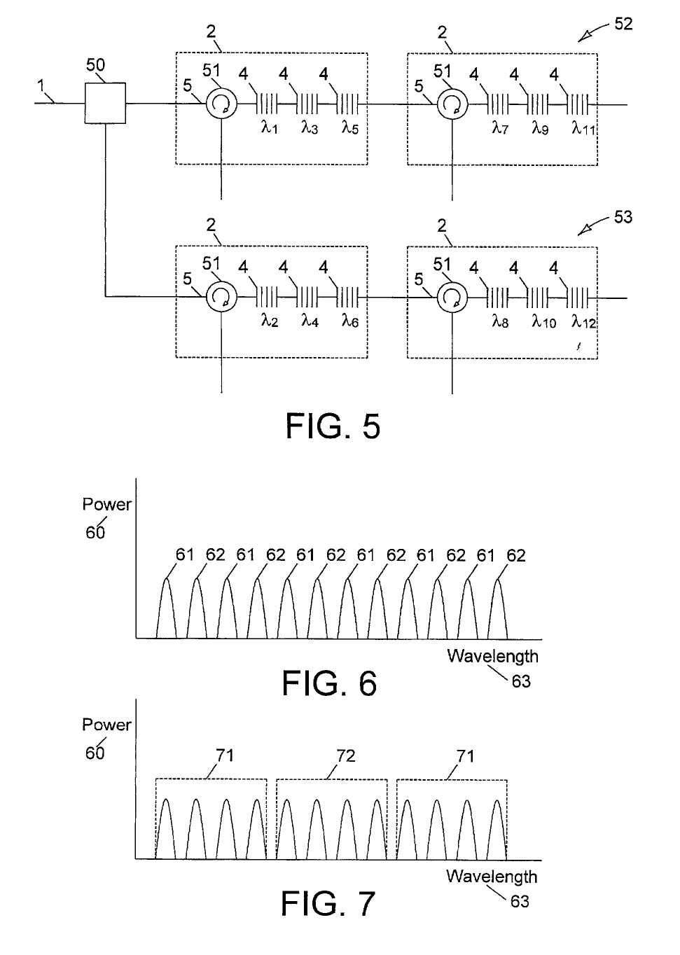

FIG. 5 depicts a demultiplexer having first and second rows 52, 53 of grating modules 2 and a coupler 50. The grating modules 2 of FIG. 5 include optical circulators 51. The coupler 50 can be a coupler or an interleaver or a switch or a broadband filter or wavelength division multiplexer or any other optical device having two outputs. The gratings 4 in the first row 52 have different wavelengths compared to the gratings in the second row 53. It should be noted that the subscripts on the wavelength channels λ₁, λ₂, to λ₁₂ shown in FIG. 5 are not intended to signify increasing wavelength. Preferably, as depicted in FIGS. 6 to 8, the gratings in each grating module 2 address grating wavelengths that are either alternate channels, alternative blocks of adjacent channels, or blocks of non-adjacent channels. FIG. 6 depicts optical power 60 contained in odd and even channels 61, 62 as a function of wavelength 63. The odd and even channels 61, 62 are alternate channels. Referring to FIG. 5, the apparatus can be configured such that the odd channels 61 are reflected from the first row 52 and the even channels are reflected by the second row 53.

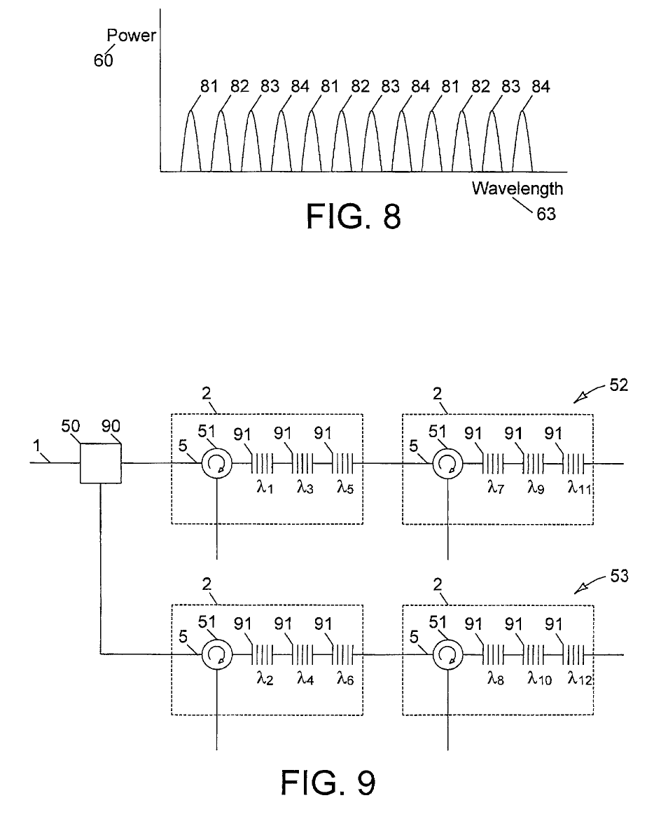

FIG. 7 depicts optical power 60 contained in odd and even blocks of channels 71, 72. Referring to FIG. 5, the apparatus can be configured such that the odd blocks of channels 71 are reflected from the first row 52 and the even blocks of channels 72 are reflected by the second row 53. FIG. 8 depicts optical power 60 contained in blocks of non-adjacent channels 81, 82, 83, 84. Referring to FIG. 5, the apparatus can be configured such that blocks of non-adjacent channels 81 and 83 are reflected from the first row 52 and blocks of non-adjacent channels 82 and 84 are reflected by the second row 53. It is preferable that each block of non-adjacent channels 81, 82, 83 or 84 is reflected by one of the grating modules 2.

The advantage of the apparatus depicted in FIG. 5 is that it can be used as both an interleaver and a dispersion compensating interleaver. The advantage for the interleaver is reduced multipath interference between the responses of the individual gratings.

FIG. 9 depicts the apparatus of FIG. 5 in which the coupler 50 is an interleaver 90 and the gratings 4 are dispersion compensators 91. The interleaver 90 separates odd and even channels, or bands of channels, into the first and second rows 52, 53. The wavelength channels λ₁, λ₂, to λ₁₂ take the same meaning as those described with reference to FIG. 5. The advantage over prior-art implementations is that the dispersion compensators 91 can be tuneable. Tuneable dispersion compensators work by changing the center wavelength or bandwidth of the grating and this can lead to optical interference from the grating on adjacent channels. Separating out the adjacent channels using the apparatus shown in FIG. 9 provides an effective solution to this problem.

FIG. 10 depicts a row of grating modules 2 in which the gratings 4 are designed such that they compensate for the dispersion in the passband of the grating induced by the dispersion in the out-of-band region of the previous gratings on adjacent channels. The first grating 101 reflects light at a wavelength λ₁ 105 and transmits light at other wavelengths, including at a wavelength λ₂ 106. The first grating 101 has a transmissive group delay 103, which induces a group delay G2 at the wavelength λ₂ 106 corresponding to the operating wavelength of the second grating 102. The second grating 102 is thus designed such that its reflective group delay 104 removes the group delay 102 introduced into the optical signal by the first grating 101. In practice it is only necessary to take into account variations in the group delay 103 across the operating wavelength of the second grating 102. A design example is shown with reference to FIGS. 22 to 24.

A similar principle applies to the grating module 2 depicted in FIG. 11 which includes a plurality of gratings 111, 112, 113, 114. Grating 112 is designed such that its group delay in reflection removes the variation in the group delay at its operating wavelength induced by grating 111 in transmission both in transmitting the optical signal forward and backward through the grating 111. Similarly, grating 113 is designed such that its group delay in reflection removes the variation in the group delay at its operating wavelength induced by both gratings 111 and 112 in transmission (forward and backward), and grating 114 is designed such that its group delay in reflection removes the variation in the group delay at its operating wavelength induced by gratings 111, 112 and 113 in transmission (forward and backward). For large wavelength separation of the gratings 111, 112, 113 and 114, the variation in group delay induced by grating 111 at the operating wavelength of grating 114 may be sufficiently small that it does not require compensating.

FIG. 12 depicts odd and even grating modules 127, 128 connected together in which the odd grating module 127 includes gratings 121, 123 and 125, and the even grating module 128 includes gratings 122 and 124. The odd grating module 127 reflect odd channels λ₁, λ₃, λ₅, and the even grating module 128 reflects even channels λ₂, λ₄. The group delay experienced by optical wavelength channels reflected by the even channel gratings 122, 124 is affected by out-of-band dispersion induced by the odd channel gratings 121, 123 and 125. It is therefore preferable to design the even channel gratings 122, 124 to remove the out-of-band dispersion induced by the odd channel gratings 121, 123, 125. This approach is particularly suited to high bit-rate systems such as 40 Gbit/s systems or to optical networks having very tight channel spacings and high-bandwidth efficiency (e.g. 12.5 GHz or 25 GHz carrying 10 Gbit/s data).

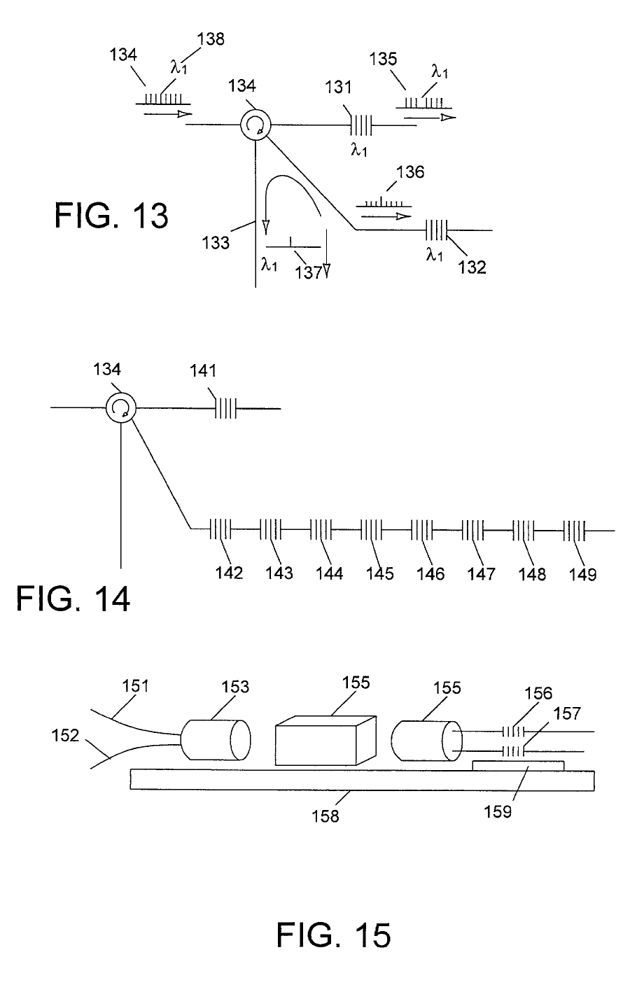

FIG. 13 depicts a channel module 130 comprising a four-port circulator 134 and first and second gratings 131, 132 that operate at the same wavelength λ₁ 138. The first grating 131 can be high-reflectivity to minimize leakage and the second grating 132 can be optimized for low cross talk to remove unwanted optical channels reflected by the first grating 131. The wavelength channel λ₁ 138 reflected by the first and second gratings 131, 132 is output at the optical tap 133. The principle is further illustrated by showing an input signal 134 comprising eight wavelength channels, an output signal 135 where a wavelength channel has been removed by the first grating 131, a reflected optical signal 136 which contains small amounts of optical power at wavelength channels other than that reflected significantly by the first and second gratings 131, 132, and a dropped optical signal 137 which contains only the desired wavelength channel. It is preferred that the group delay variation of at least one of the first and second gratings 131, 132 is configured such that the overall group delay variation of the channel module 130 is controlled. Only one wavelength channel has been shown for simplicity of illustration. The concept can be extended as shown in FIG. 14 where the grating 141 is a multichannel grating for removing a plurality of wavelength channels from the optical signal, and there are provided gratings 142-149 which provide exceptional low cross-talk. Grating 141 has high reflectivity at the wavelengths at which it reflects, for example greater than 90%, and preferably greater than 99%. Gratings 142 to 149 have exceptional low cross-talk, for example the out-of-band rejection should be greater than 35 dB, and preferably greater than 50 dB. Control of the overall group delay variation is preferred. For example, the signal reflected by grating 149 will contain distortion arising from the group delay variation induced by grating 141 in reflection, and by twice the group delay of gratings 141 to 148 in transmission. An example of how to remove this group delay variation is provided with reference to FIGS. 22 to 24. It should be noted that all of the possible wavelength channels have note been noted, and that other wavelength channels can be present.

FIG. 15 depicts a filter 150 comprising an input and output fiber 151, 152 connected to a first graded index lens 153, a Faraday rotator 154, and a second graded index lens 155 collimating light into a first and second grating 156, 157. The filter 150 is preferably built onto a substrate 158 to provide thermal stability. The substrate 158 can also be designed such that the lengths of the first and second gratings 156, 157 are reduced by an athermal mount 159 with increasing temperature in order to athermalise the filter 150. Techniques to athermalize the package are known. See for instance U.S. Pat. No. 5,042,898. The filter 150 can also include optical isolators and polarization manipulating components such as waveplates and polarizes. The design is particularly suited to the packaging of distributed feedback fiber lasers.

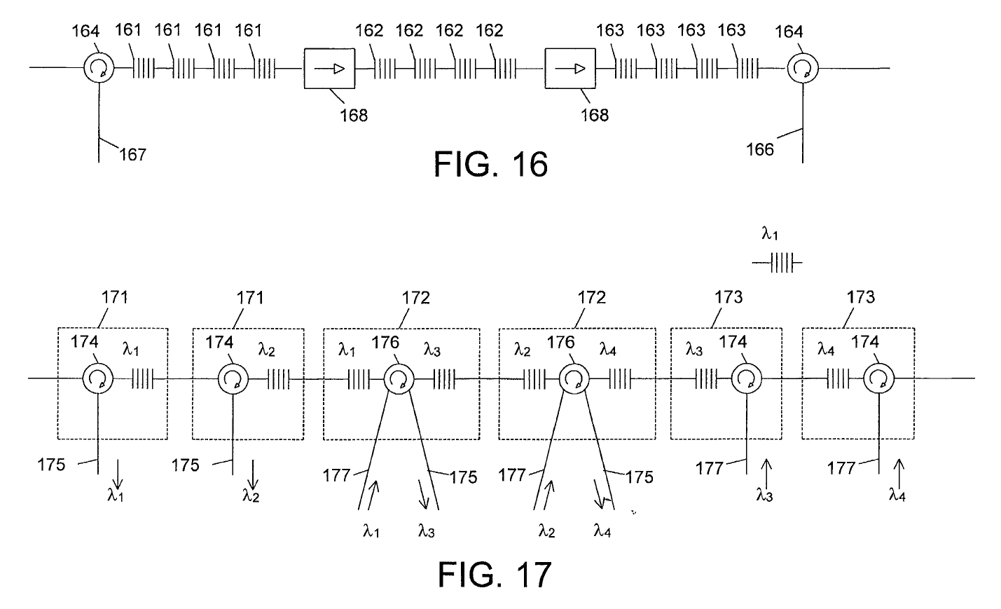

FIG. 16 depicts a grating module 160 having first and second circulators 164, 165, first gratings 161, second gratings 162 and third gratings 163, in which the first gratings 161 separate the wavelength channels and remove them via a “drop port” 167, the second gratings 162 attenuate the separated wavelengths, and the third gratings 163 add wavelength channels from an add port 166. The added wavelength channels in add port 166 can be provided from the wavelength channels removed in the drop port 167, for example after suitable processing, or from a different optical signal. The grating module 160 can be incorporated into the apparatus depicted in FIGS. 1 to 3 or can be used as a stand-alone add-drop multiplexer. The grating module 160 can include either single first, second and third gratings 161, 162, 163, or banks of gratings as depicted. It is preferable to include isolators 168 in the grating module 160 as depicted. The four second gratings 162 can be implemented with fewer components, for example by a single grating covering the four channels that are dropped. If the four second gratings 162 reflect adjacent wavelength channels, then the single grating can be a wideband grating. However if the four second gratings 162 reflect non-adjacent wavelength channels then the single grating is preferably designed to reflect multi-wavelength channels. It is preferable to configure the first, second and third gratings 161, 162, 163 to control group delay.

FIG. 17 depicts an add-drop multiplexer 170 having two first grating modules 171, a plurality of second grating modules 172 and two third grating modules 173. The first grating modules 171 include three port circulators 174 and drop ports 175, the second grating modules 172 include four port circulators 176, add ports 177 and drop ports 175, and the third grating modules 173 include three port circulators 174 and add ports 177. The wavelength channels λ₁, λ₂, λ₃, λ₄ are different wavelength channels from each other. The advantage of this configuration is that the add-drop multiplexer 170 uses less circulators and has less loss in the express path 178 than conventional arrangements. It is preferable to configure the first, second and third grating modules 171, 172, 173 to control group delay.

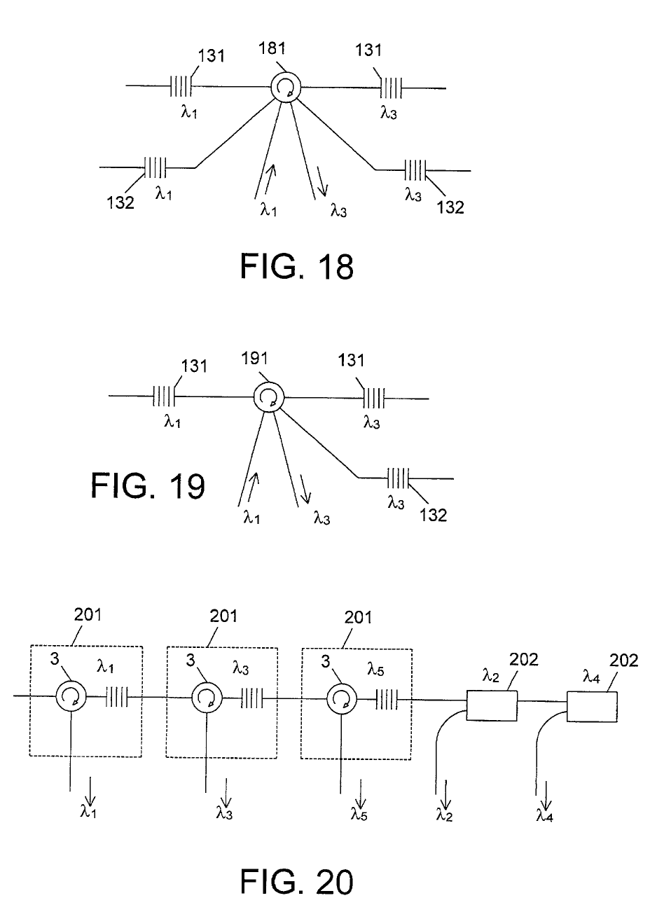

The second grating module 172 can incorporate a six-port circulator 181 and first and second gratings 131, 132 as shown in FIG. 18 for reducing cross talk and increasing isolation. Alternatively, the second grating module 172 can incorporate a five port circulator 191 and first and second gratings 131, 132 as shown in FIG. 19 for reducing cross talk and increasing isolation.

The apparatus depicted in FIG. 20 includes a plurality of grating modules 201 and a plurality of thin-film filter modules 202. It is preferable that the grating modules 201 separate odd wavelength channels λ₁, λ₃, λ₅, and the thin-film filter modules 202 drop even wavelength channels λ₂, λ₄. Preferably, the grating modules 201 will include gratings having the lowest and the highest wavelengths in the optical signal in order to reduce any out-of-band filtration of wavelength channels not contained within the pass bands of the grating and thin-film modules 201, 202. The grating modules 201 reduce the channel density allowing lower-performance optical filters to be used. The lower-performance optical filters can alternatively be grating modules having lower-cost gratings, or a combination of lower cost gratings and thin-film filters or other demultiplexers. This approach is particularly attractive for demultiplexing optical signals on narrow grids such as 50 GHz, 25 GHz or 12.5 GHz. It is preferable to configure the grating modules 201 to control group delay.

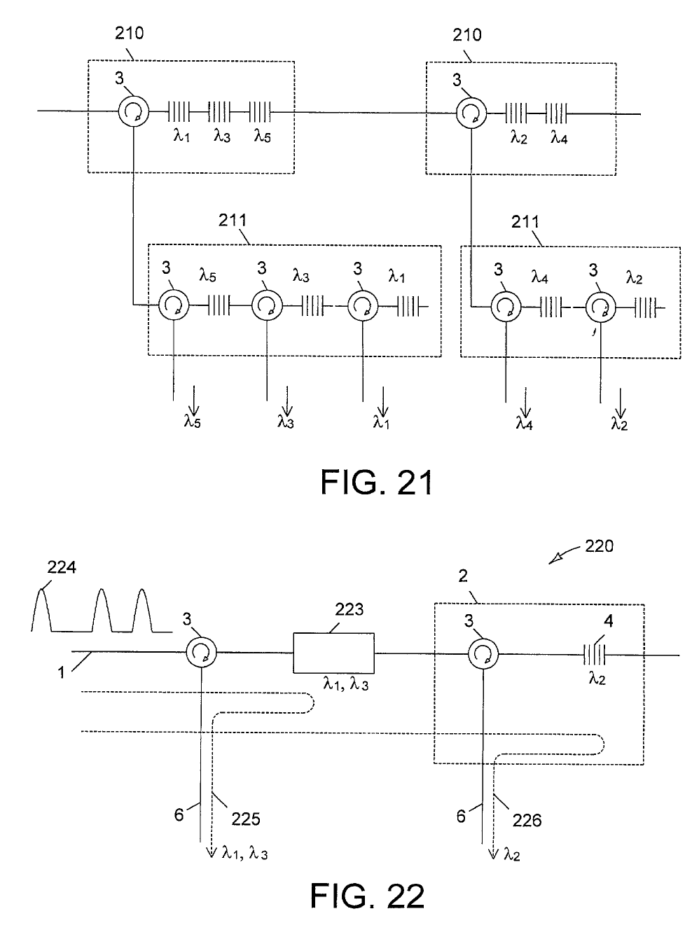

FIG. 21 depicts a demultiplexer having first grating modules 210 connected to second grating modules 211. The first grating modules 210 reflect several wavelength channels that are filtered by the second grating module 211 in order to improve channel isolation. It is preferable to configure at least one of the first and second grating modules 210, 211 to control group delay. The wavelength channels shown λ₁, λ₂, λ₃, λ₄, λ₅ can be adjacent wavelength channels with either increasing or decreasing wavelengths.

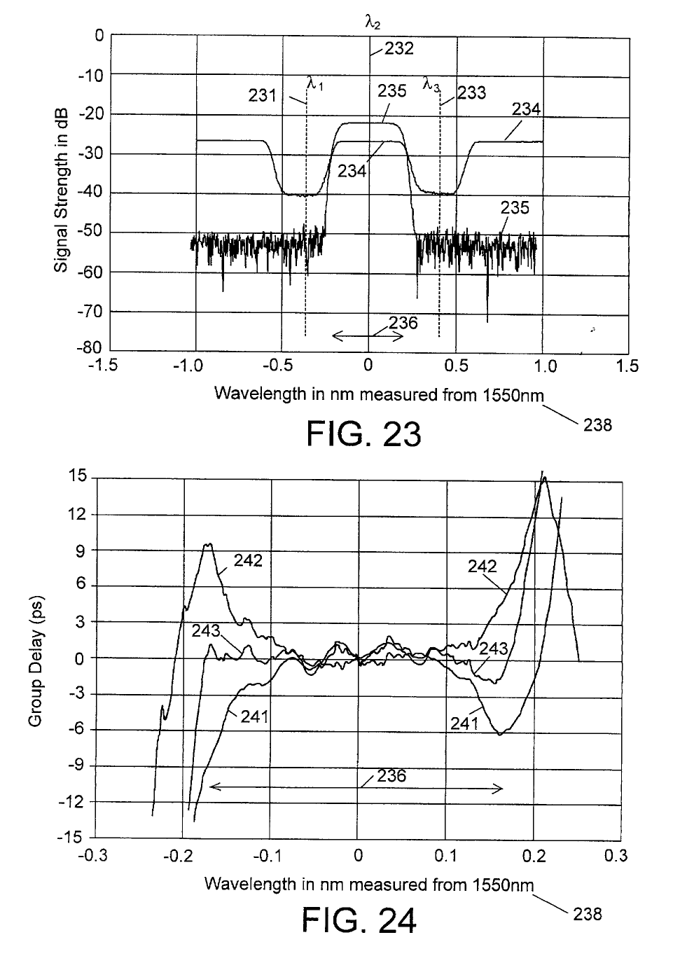

FIG. 22 depicts a demultiplexer comprising a filter 223 and a fiber Bragg grating 4. FIG. 23 depicts the amplitude response 234 of the filter 223 in transmission, and the amplitude response 235 of the fiber Bragg grating 4 in reflection as a function of wavelength 238. In this example, the filter 223 reflects a signal 225 at wavelengths λ₁ and λ₃ 231, 233 and the fiber Bragg grating 4 reflects a signal 226 at a wavelength λ₂ 232. Note that the input signal 224 comprises the signal 225 and the signal 226, and may further comprise other wavelength channels. The operating wavelength range 236 of the fiber Bragg grating 4 is defined in FIG. 23 as being the range over which the amplitude response 235 is substantially flat. Many other definitions can be used for the operating wavelength range 236 such as the −3 dB bandwidth, the −1 dB bandwidth or the −0.2 dB bandwidth. Alternatively, the operating wavelength range 236 can be defined from examination of the group delay characteristics of the grating 4.

FIG. 24 depicts the measured group delay response 242 in transmission of the filter 223 in the grating's operating wavelength range 236. The group delay 242 should preferably be substantially constant over the operating wavelength range 236 so that the filter 223 does not add any substantial dispersion. However the group delay variation 242 is clearly non-linear, and this is highly undesirable and will lead to additional dispersion and pulse distortion in high-speed telecommunication networks.

The solution is to compensate for the group delay variation 242 by the design of the fiber Bragg grating 4. This can be achieved using inverse scattering algorithms (see for example R. Feced, M. N. Zervas and M. A. Muriel, “An efficient inverse scattering algorithm for the design of nonuniform fibre Bragg gratings”, IEEE Journal of Quantum Electronics, Vol 35, pp 1105-1115, (1999), or copending U.S. patent application Ser. No. 09/629,651, which is hereby incorporated by reference herein in its entirety). The grating 4 was designed using the inverse scattering algorithm and manufactured using the precision grating writing process as defined in U.S. Pat. No. 6,072,926, which is hereby incorporated by reference herein in its entirety. FIG. 24 depicts the measured group delay variation 241 of the fiber Bragg grating 4 in reflection, together with the overall group delay variation 243 of the demultiplexer 220. The overall group delay variation 243 is substantially constant over the operating wavelength range 236. Note, that instead of designing the grating 4 such that the overall group delay variation 243 is substantially constant, the grating 4 could have been designed such that the overall group delay variation 243 varied substantially linearly over the operating wavelength range 236 and can thus provide dispersion compensation for components elsewhere in the network.

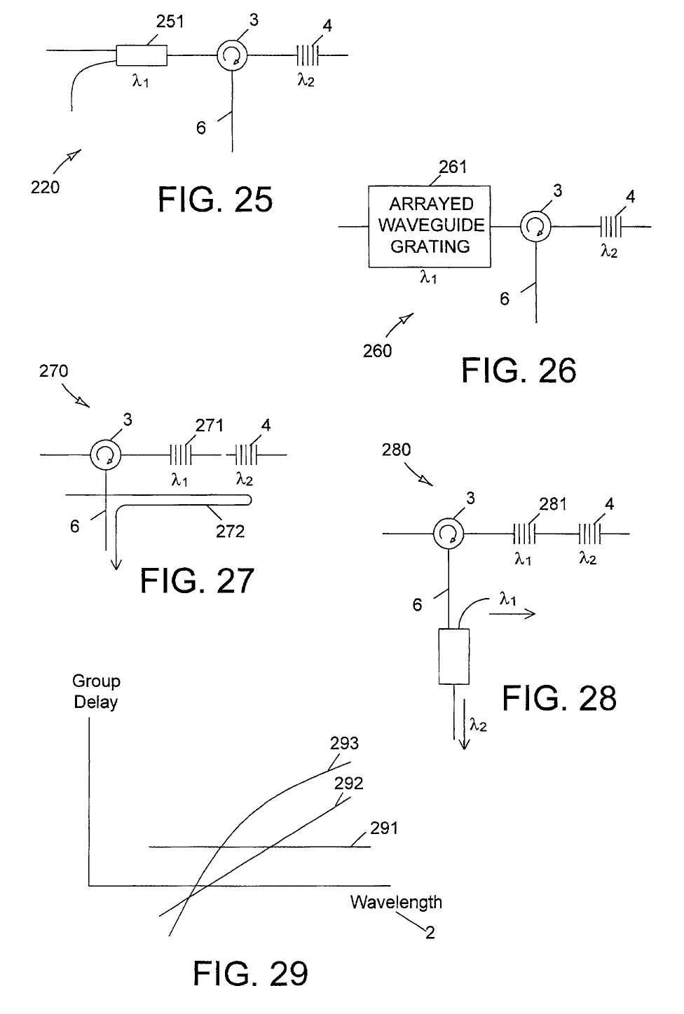

The filter 223 in the demultiplexer 220 was configured as two fiber Bragg gratings connected in series. However, a similar approach can be used with other filters, such as the thin film filter 251 of the demultiplexer 250 depicted in FIG. 25 and the arrayed waveguide grating 261 of the demuliplexer 260 depicted in FIG. 26. In each of FIGS. 22, 25 and 26, the signal passes through the filter once prior to being reflected by the fiber Bragg grating 4.

FIG. 27 depicts a demultiplexer 270 wherein the signal 272 reflected by the grating 4 passes through filters 271 twice. In this case, the grating 4 needs to be designed to cancel out twice the group delay variation of the filter 271 in transmission.

FIG. 28 depicts a demultiplexer 280 wherein the signal reflected by the grating 4 passes through a filter 281 twice and a filter 282 once. It is preferred that the grating 4 is designed to compensate for twice the group delay variation of the filter 281 plus one times the group delay variation of the filter 282. It is also preferred that the grating 281 is designed to compensate for the group delay variation of the filter 282 around the wavelength λ₁.

It is preferable that overall group delay variation 243 is equal to a desired amount minus the sum of the accumulated group delay arising from the group delay characteristics 242 of the filter or filters 223 at the operating wavelength range 236. The desired amount can be a constant 291, a substantially linear variation 292 with wavelength 290, or be defined by a non-linear variation 293 with wavelength 290 as shown in FIG. 29.

The general design principles are general and can be applied to the embodiments shown in FIGS. 1 through to 22 in order to design and manufacture demultiplexers.

While the above invention has been described in language more or less specific as to structural and methodical features, it is to be understood, however, that the invention is not limited to the specific features shown and described, since the means herein disclosed include preferred forms of putting the invention into effect. The invention is, therefore, claimed in any of its forms or modifications within the proper scope of the appended claims appropriately interpreted in accordance with the doctrine of equivalents.

We claim:

1. An apparatus for demultiplexing a wavelength division multiplexed optical signal having a plurality of wavelength channels each at a different signal wavelength, comprising:
a signal port; and
a plurality of grating modules each comprising a coupler and a fiber Bragg grating having a unique wavelength, and wherein:
the grating modules each have an input port, an optical tap and an output port;
the grating modules are configured in a row having a first end and a second end by connecting the output port of each grating module to the input port of another grating module;
the first end is connected to the signal port; and
the grating modules reflect different signal wavelengths which are output via the optical taps.

2. The apparatus of claim 1, and further wherein at least one of the couplers is an optical circulator.

3. The apparatus of claim 1, and further wherein at least one grating module comprises a plurality of gratings reflecting at unique wavelengths.

4. The apparatus of claim 1, and further wherein at least one fiber Bragg grating is a broadband fiber Bragg grating designed to reflect more than one wavelength channel.

5. The apparatus of claim 4, and further wherein the wavelength channels are not adjacent.

6. The apparatus of claim 1, and further wherein at least one fiber Bragg grating is a multi channel fiber Bragg grating designed to reflect more than one wavelength channel.

7. The apparatus of claim 1, and further comprising a demultiplexer having a plurality of demultiplexer input ports and wherein the optical tap of the at least one grating module is connected to the demultiplexer input port.

8. The apparatus of claim 1, and further wherein at least one of the fiber Bragg gratings is a dispersion compensator.

9. The apparatus of claim 1, and further wherein at least one of the optical taps is connected to an optical multiplexer.

10. The apparatus of claim 9, and further wherein the optical multiplexer comprises an arrayed waveguide grating.

11. The apparatus of claim 9, and further wherein the optical multiplexer comprises a plurality of thin-film filters.

12. The apparatus of claim 1, and further wherein at least one of the optical taps is connected to a detector.

13. The apparatus of claim 1, and further wherein at least one of the optical taps is connected to an optical switch.

14. The apparatus of claim 1, and further wherein the second end of the row of optical gratings is connected to a detector.

15. The apparatus of claim 14, and further wherein the optical signal further comprises a control signal at a control wavelength selected to pass through the grating modules to the second end of the row of optical gratings.

16. The apparatus of claim 1, and further wherein the apparatus further comprises a filter and at least one fiber Bragg grating, and wherein the fiber Bragg grating is configured to control the group delay characteristic of the filter.

17. An apparatus for demultiplexing a wavelength division multiplexed optical signal having a plurality of wavelength channels each at a different signal wavelength, the apparatus comprising:
a signal port;
a grating module comprising a coupler and a fiber Bragg grating; and
a filter having a group delay characteristic, and wherein:
the fiber Bragg grating has a reflective group delay characteristic and an operating wavelength range;
the filter has a group delay variation around the grating's operating wavelength range;
the apparatus is configured such that the signal passes through the filter at least once and is reflected by the grating; and
the reflective group delay characteristic provides a controlled group delay around the grating's operating wavelength range.

18. The apparatus of claim 17, and further wherein the filter is a thin film filter.

19. The apparatus of claim 17, and further wherein the filter is an arrayed waveguide grating.

20. The apparatus of claim 17, and further wherein the filter is a fiber Bragg grating.

21. The apparatus of claim 17, and further wherein the apparatus is configured such that the signal passes through the filter once, and the reflective group delay characteristic around the grating's operating wavelength range is substantially equal to a desired amount minus the filter's group delay characteristic.

22. The apparatus of claim 17, and further wherein the apparatus is configured such that the signal passes through the filter twice, and the reflective group delay characteristic around the grating's operating wavelength range is substantially equal to a desired amount minus twice the filter's group delay characteristic.

23. The apparatus of claim 17, and further comprising a plurality of filters, and further wherein the signal passes through the plurality of filters at least once, and the reflective group delay characteristic around the grating's operating wavelength range is substantially equal to a desired amount minus the sum of the accumulated group delay arising from the plurality filter's group delay characteristics at the operating wavelength range.

24. The apparatus of claim 21, and further wherein the desired amount is a constant.

25. The apparatus of claim 21, and further wherein the desired amount is a substantially linear variation with wavelength.

26. The apparatus of claim 21, and further wherein the desired amount is a defined non-linear variation with wavelength.
